(19) United States
(12) Patent Application Publication
(10) Pub. No.: US 2002/0078438 A1
(43) Pub. Date: Jun. 20, 2002

(54) Video signal analysis and storage

(75) Inventor: Alexis S. Ashley, Redhill (GB)

Correspondence Address: Corporate Patent Counsel, U.S. Philips Corporation, 580 White Plains Road, Tarrytown, NY, 10591, US

(73) Assignee: U.S. Philps Corporation

(21) Appl. No.: 09/811,729

(22) Filed: Mar. 19, 2001

(30) Foreign Application Priority Data
Mar. 31, 2000 (GB) 0007861.8

(51) Int. Cl. H04N 7/16

(52) U.S. Cl. 725/1

(57) ABSTRACT

In a method of detecting a scene cut, compressed audio data is analysed to determine variations across a number of frequency bands of a particular parameter. The audio data includes, for each sample and for a plurality of audio frequency bands, a parameter indicating the maximum value of the compressed audio data for that frequency band. The method comprises the steps of determining, for each of a number of the frequency bands, an average of the parameters for a number of consecutive samples, calculating, for each of the number of frequency bands, a variation parameter indicating the variation of the determined average over a number, M, of consecutive determined averages, comparing the variation parameter for the predetermined number of the frequency bands with threshold levels and, determining from the comparison whether a scene cut has occurred.

The present invention relates to a method and apparatus for use in processing audio plus video data streams in which the audio stream is digitally compressed and in particular, although not exclusively, to the automated detection and logging of scene changes.

A distinction is drawn there between what is referred to by the term “scene change” or “scene cut” in some prior publications and the meaning of these terms as used herein. In these prior publications, the term “scene changes” (also variously referred to as “edit points” and “shot cuts”) has been used to refer to any discontinuity in the video stream arising from editing of the video or changing camera shot during a scene. Where appropriate such instances are referred to herein as “shot changes” or “shot cuts”. As used herein, “scene changes” or “scene cuts” are those points accompanied by a change of context in the displayed material. For example, a scene may show two actors talking, with repeated shot changes between two cameras focused on the respective actors' faces and perhaps one or more additional cameras giving wider or different angled shots. A scene change only occurs when there is a change in the action location or time.

An example of a system and method for the detection and logging of scene changes is described in international patent application WO98/43408. In the described method and system, changes in background level of recorded audio streams are used to determine cuts which are then stored with the audio and video data to be used during playback. By detecting discontinuities in audio background levels, scene changes are identified and distinguished from mere shot changes where background audio levels will generally remain fairly constant.

In recent advances in audio-video technology, the use of digital compression on both audio and video streams has become common. Compression of audio-visual streams is particularly advantageous in that more data can be stored on the same capacity media and the complexity of the data stored can be increased due to the increased storage capacity. However, a disadvantage of compressing the data is that in order to apply methods and systems such as those described above, it is necessary to first decompress the audio-visual streams to be able to process the raw data. Given the complexity of the compression and decompression algorithms used, this becomes a computationally expensive process.

The present invention seeks to provide means for detection of scene changes in a video stream using a corresponding digitally compressed audio stream without the need for decompression.

In digital audio compression systems, such as MPEG audio and Dolby AC-3, frequency based transforms are applied to uncompressed digital audio. These transforms allow human audio perception models to be applied so that inaudible sound can be removed in order to reduce the audio bit-rate. When decoded, these frequency transforms are reversed to produce an audio signal corresponding to the original.

In the case of MPEG audio, the time-frequency audio signal is split into sections called sub-bands. Each sub-band refers to a frequency range in the original signal, starting from sub-band 0, which covers the lowest frequencies, up to sub-band 32, which covers the highest frequencies. Each sub-band has an associated scale factor and set of coefficients for use in the decoding process. Each scale factor is calculated by determining the absolute maximum value of the sub-band's samples and quantizing that value to 6 bits. The scale factor is a multiplier which is applied to coefficients of the sub-band. A large scale factor commonly indicates that there is a strong signal in that frequency range whilst a small factor indicates that there is a low signal in that frequency range.

According to one aspect of the present invention, there is provided a method of detecting a scene cut by analyzing compressed audio data, the audio data including, for each sample and for a plurality of audio frequency bands, a parameter indicating the maximum value of the compressed audio data for that frequency band, the method comprising the steps of:

determining, for each of a number of the frequency bands, an average of the parameters for a number of consecutive samples;

calculating, for each of the number of frequency bands, a variation parameter indicating the variation of the determined average over a number, M, of consecutive determined averages;

comparing the variation parameter for the predetermined number of the frequency bands with threshold levels; and,

determining from the comparison whether a scene cut has occurred.

The audio variation in any particular frequency band is calculated in accordance with the invention by the computation of a mean of the maximum value parameters followed by the computation of the variance over a number of these mean values. The invention uses maximum value parameters which form part of the compressed audio data, thereby avoiding the need to perform decompression before analysing the data.

The compression method may comprise MPEG compression, in which case the maximum value parameters comprise scale factors, and the frequency bands comprise the sub-bands of the MPEG compression scheme.

Preferably, the variation parameter is the variance of the average scale factors, and if the variance is greater than a moving average of these average scale factors, this is indicative of a significant change in the audio signal within this sub-band.

Analysis of this nature over a selected number of sub-bands is used to determine if there has been a significant change in the audio stream, which implies that a scene cut has taken place.

It is possible to improve the detection rate by increasing the number of mean calculations used in the variance check. However, this has the effect of increasing the length of time over which data is required for the scene cut evaluation, thereby reducing the accuracy with which the timing of the scene cut can be determined.

An example of the present invention will now be described in detail with reference to the accompanying drawings, in which:

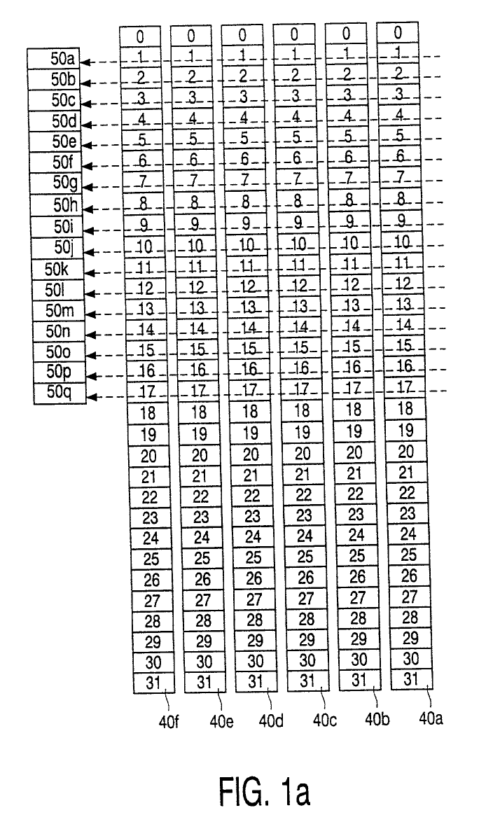

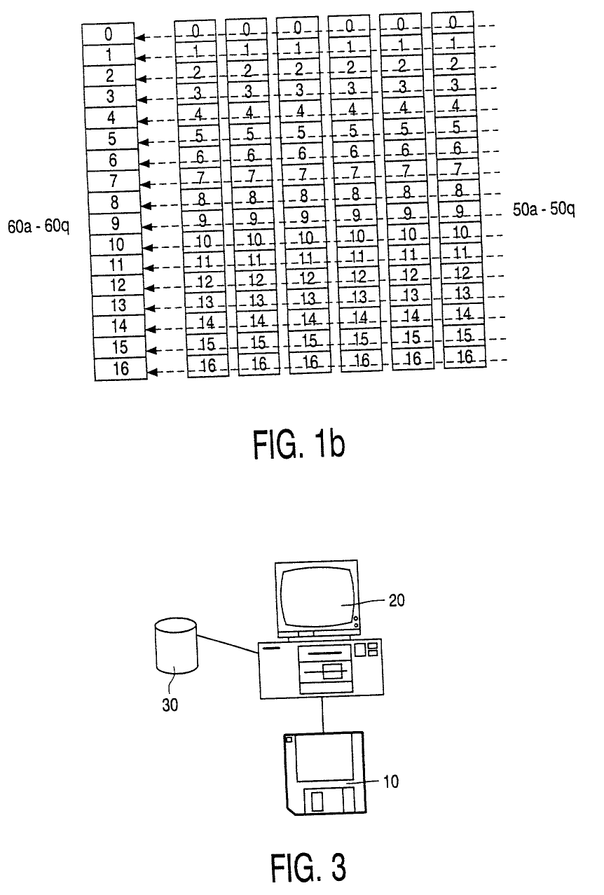

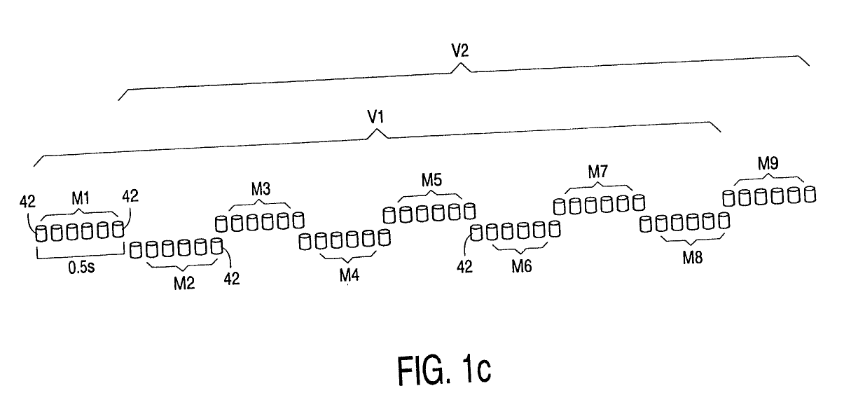

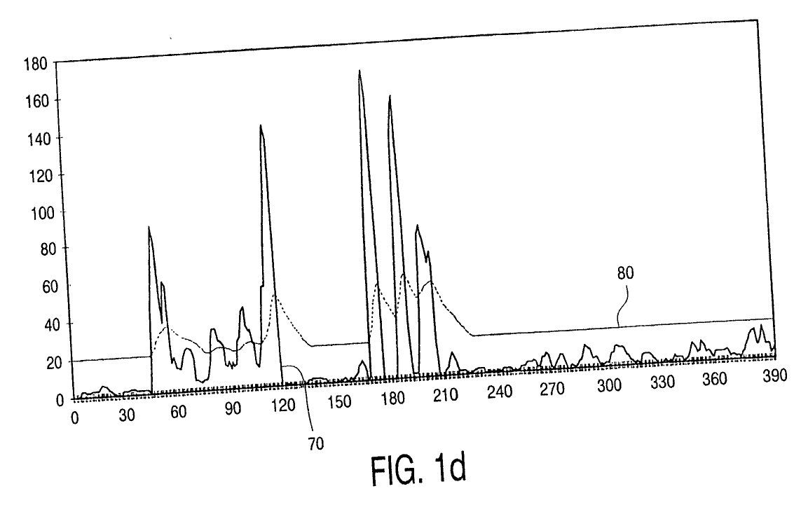

FIGS. 1a, 1b and 1c are schematic diagrams illustrating steps of method according to the present invention;

FIG. 1d is a graph illustrating a step of the method according to the present invention;

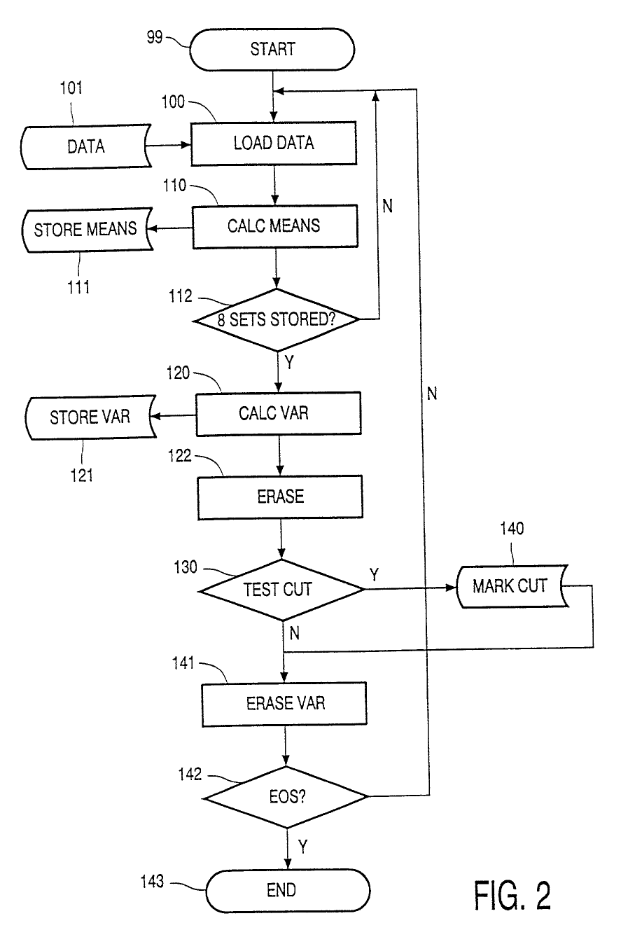

FIG. 2 is a flowchart of the steps performed in a method of detecting scene cuts according to one aspect of the present invention; and,

FIG. 3 is a block-schematic diagram of an apparatus for detecting scene cuts according to another aspect of the present invention.

FIG. 1a is a block schematic diagram illustrating a step of a method according to the present invention. Six samples blocks 40a to 40f are shown, each sample block representing a predetermined number of audio data samples. In the example to be described, each sample block comprises compressed audio data for 0.5 seconds of audio. For each sample block 40, sub-bands 0-31 are represented. Each sub-band 0 to 31 provides data concerning the audio over a respective frequency band. Using the example of MPEG audio compression, the scale factors for the audio samples which make up each 0.5 s sample block 40 are stored in the individual array locations of FIG. 1a.

For a subset of the sub-bands, the mean of the scale factors is calculated for each sample block, namely the mean scale factor over each 0.5 second period. This mean scale factor is stored in array 50a-50q, which thus contains, for each sample block 40:

$$\frac{\sum scalefactors}{no . samples}$$

The array 50a-50q is multidimensional, allowing a number of mean calculations for each sub-band to be stored, so that it contains the mean scale factor for a plurality of the sample blocks 40a-40f.

The mean calculation is repeated for each sub-band for a number of sample blocks 40 until a predetermined number of calculations have been performed and the results stored in array 50a-50q. In this example, 8 mean calculations for each sub-band are stored in each respective array element 50a-50q. Thus, the mean calculations cover eight 0.5 second sample blocks (although only six are shown in FIG. 1a). Once eight sets of mean calculations have been stored in the respective array element 50a-50q for each sub-band, a variance operation is performed as is illustrated in FIG. 1b.

The statistical variance for each set of 8 mean calculations stored in array 50a-50q is calculated and stored in a corresponding array element 60a-60q. Where the variance of at least 50% of the sub-bands at any one time period is greater than a moving average, a potential scene cut is noted.

Once the variance calculations for each set of 8 mean calculations is determined and stored, the earliest mean calculation is removed from the respective array element 50a-50q and the remaining 7 mean calculations are advanced one position in the respective array element 50a-50q to allow space for a new mean calculation. In this manner, the variance for each sub-band is calculated over a moving window, updated in this instance every 0.5 seconds, as is shown in FIG. 1c.

FIG. 1c is used to explain graphically the calculations performed, for one sub-band. In FIG. 1c each data element 42 comprises the scale factor for one sample in the particular frequency band. By way of example, six samples 40 are shown to make up each 0.5 second sample block. The mean M1-M9 of the scale factors of the six samples for each sample block is then calculated.

The variance 8 consecutive values of the means M1-M9 is calculated to give variances V1 and V2, progress in time. Thus V1 is the variance for means M1 to M8, and V2 is the variance for means M2 to M9, as shown. The variance V1 is compared with the average of means M1 to M8, and so on.

FIG. 1d is a graph illustrating the variance 70 plotted against the moving average 80 for one sub-band over time. Obviously the comparison of variance against the moving average can be performed once all variances have been calculated or once the variance for each sub-band for a particular time period had been calculated.

FIG. 2 is a flowchart of the steps performed in a method of detecting scene cuts according to an aspect of the present invention. Following a Start at 99, in step 100, a portion of data from each sub-band of a compressed audio stream (represented at 101) is loaded into a buffer. In this example the portions are set at 0.5 seconds in duration. In step 110, for each sub-band, the mean value of the scale factors of the loaded portion of data is calculated. The mean values of the scale factors are stored at 111. Check step 112 causes steps 100 and 110 to be repeated on subsequent portions of the audio data stream until a predetermined number, in this example 8, of mean values have been calculated and stored for each sub-band. In step 120, a variance (VAR) calculation is performed on the 8 mean calculations for each sub-band and is then stored at 121. Following the erasing at 122 of the earliest set of mean values from store 111, the calculated variance is compared with a moving average in step 130 and, if the variance of 50% or over of the sub-bands is greater than the moving average, the portion of the data stream is marked as a potential scene cut in step 140.

Following the marking of a potential cut in step 140, or following determination in step 130 that the variance of 50% or over of the sub-bands is less than the moving average, the stored variance (VAR) in 121 is erased at step 141. Check 142 determines whether the end of stream (EOS) has been reached: if not, the process reverts to step 100; if so, the process ends at 143.

FIG. 3 is a block-schematic diagram of a system for use in detecting scene cuts according to an aspect of the present invention. A source of audio visual data 10, which might, for example, be a computer readable storage medium such as a hard disk or a Digital Versatile Disk (DVD), is connected to a processor 20 coupled to a memory 30. The processor 20 sequentially reads the audio stream and divides each sub-band into 0.5 second periods. The method of FIG. 1 is then applied to the divided audio data to determine scene cuts. The time point for each scene cut is then recorded either on the data store 10 or on a further data store.

In experimental analysis, a 0.5 second time period was used for mean calculations and a variance of the last 8 mean calculations was determined. A threshold was set such that 50% of the sub-bands must be greater than a moving average in order for a scene cut to be detected. These parameters provided a detection rate that allowed scene cuts to be detected within 4 seconds of their occurrence.

For MPEG encoded audio it was found that the best results were achieved if only sub-bands 1 to 17 were analysed in this manner to determine scene cuts. The basic computer algorithm implemented to perform the experimental analysis was shown to require only 15% of the CPU time of a Pentium (Pentium is a registered Trademark of Intel Corporation) P166MMX processor. Obviously, the selection of sub-bands to be processed can be varied in dependence on the accuracy required and the availability of the processing power.

It would be apparent to the skilled reader that the method and system of the present invention may be combined with video processing methods to further refine determination of scene cuts, the combination of results either being used once each system has separately determined scene cut positions or in combination to determine scene cuts by requiring both audio and visual indications in order to pass the threshold indicating a scene cut.

Although specific calculations have been described in detail, various other specific calculations will be envisaged by those skilled in the art. The discussion of calculations for 8 sample blocks and of 0.5 second sample block durations is not intended to be limiting. Furthermore, there are various statistical calculations for obtaining a parameter representing the variation of samples, other than variance. For example standard deviation calculations are equally applicable. The variance values may be compared with a constant numerical value rather than the moving average as discussed above. All of these variations will be apparent to those skilled in the art.

1. A method of detecting a scene cut by analyzing compressed audio data, the audio data including, for each sample and for a plurality of audio frequency bands, a parameter indicating the maximum value of the compressed audio data for that frequency band, the method comprising the steps of:
determining, for each of a number of the frequency bands, an average of the parameters for a number of consecutive samples;
calculating, for each of the number of frequency bands, a variation parameter indicating the variation of the determined average over a number, M, of consecutive determined averages;
comparing the variation parameter for the predetermined number of the frequency bands with threshold levels; and,
determining from the comparison whether a scene cut has occurred.

2. A method according to claim 1, in which the number of consecutive samples corresponds to 0.5 seconds of data.

3. A method according to claim 1, in which the number M is 8.

4. A method according to claim 1, in which the variation parameter is the statistical variance.

5. A method according to claim 1, in which the threshold levels comprise, for each frequency band, a moving average of the determined averages.

6. A method according to claim 5, in which the threshold levels comprises the moving average of M determined averages.

7. A method according to claim 1, in which a scene cut is determined if the comparisons for 50% or more of the frequency bands exceed the threshold.

8. A method according to claim 1, in which the parameter indicating the maximum value comprises a scale factor and the frequency bands comprise sub-bands of MPEG compressed audio.

9. A method according to claim 8, in which the predetermined number of the frequency bands comprise sub-bands 1 to 17.
